(19) United States
(12) Patent Application Publication
(10) Pub. No.: US 2011/0019087 A1
(43) Pub. Date: Jan. 27, 2011

(54) METHOD AND SYSTEM FOR DISPLAYING MULTIMEDIA SUBTITLE

(75) Inventors: HSIANG-HUA CHAO, TAIPEI (TW); CHI-CHEN CHENG, TAIPEI (TW)

Correspondence Address: PAI PATENT & TRADEMARK LAW FIRM, 1001 FOURTH AVENUE, SUITE 3200, SEATTLE, WA, 98154, US

(73) Assignee: IPEER MULTIMEDIA INTERNATIONAL LTD., TAIPEI (TW)

(21) Appl. No.: 12/729,062

(22) Filed: Mar. 22, 2010

(30) Foreign Application Priority Data
Jul. 27, 2009 (TW) 098125252

(51) Int. Cl. H04N 7/00

(52) U.S. Cl. 348/468; 348/E07.001

(57) ABSTRACT

A multimedia subtitle display method and the related system are disclosed. The invention provides a technology to dynamically adjust the subtitle displayed on a screen according to the real-time detection of display environment. Particularly a system detection routine is introduced into a multimedia playback system. In the beginning of playing the multimedia, a multimedia file and a subtitle file are respectively read by the routine in real time. The tags relating to the texts recorded in the subtitle file are used to determine a subtitle display sequence. The information relating to the system resources are further read by the routine. Based on the obtained display resolution, system language and the subtitle display sequence, a display mode is decided. The multimedia playback system plays the multimedia content combined with the subtitle subsequently.

### BACKGROUND OF THE INVENTION

1. Field of the Invention

The present invention relates to a method and a system for displaying multimedia subtitle, more particularly to introduce a system detection routine into a multimedia playback system that reads a multimedia content and the related subtitle, and dynamically adjust the subtitle displayed on a screen based on the detected hardware resources.

2. Description of Related Art

With the developing progress of science and technology, the portable electronic devices are getting more functional. More portable electronic devices provide the function of reading, listening to music, or watching video. Examples of the electronic device are the well-known MP3 device, PDA, and the cellular phone capable of playing video.

Since the digitalized multimedia file, including text, video and music, records every kind of information, which can be displayed as playing the multimedia through the above-described electronic devices. For example, when the MP3 file is played, the relevant lyrics can be extracted simultaneously. The MP3 file plays after combining the lyrics and the music. The related art refers to U.S. Patent Pub. No.2007/0282844 (published on Sep. 6, 2007). 2007/0282844 has disclosed a technology of providing lyrics to the digital audio. Reference is made to playing the MP3, the MP3 file includes the synchronized lyrics that is displayed with playing the music.

In another conventional art, a separate subtitle file is loaded as synchronously playing music. There are plural recorded delimiters accompanied with the lyrics in the subtitle file. In which, the delimiters are used to remark the displaying time or other display effect of the lyrics as word-by-word, so as to display synchronously with the music. Further reference is made to U.S. patent application Publication No. 2007/0166683, which is published on Jul. 19, 2007. FIG. 1 of the reference shows a flow chart of the mentioned delimiters used to display the dynamic lyrics for a portable media device.

FIG. 1 shows the normal steps of playing by the most music player. When the music is played, a corresponding subtitle file is provided. The subtitle will be read and display synchronously. Such as the step S101, it displays as beginning to read out the delimiters from a lyrics file and reads the strings in next step S103. Because the normal player needs not to read and display the lyrics word by word, or to prompt a user the word corresponding to a current tone, the string is displayed instantly after reading (step S105). Next, step S107 describes the step to determine font, color, timing, or a start-and-end effect of fading in or fading out in accordance with the delimiters.

After that, the step S109 is to determine whether or not to display a next string. If there is no string to be displayed, it means the previous time does not end, no any string needs to be updated and still stays in step S109. If there is a next string to be displayed, step S111 then determines whether or not to display more lyrics. If there are more lyrics to be displayed, it means the section does not yet end, the step goes back to step S101 and goes through the steps of reading the strings and delimiters in the subtitle file and the foregoing steps. If there is no more lyrics to be displayed, it shows the string ends.

FIG. 2 lists an example of the delimiters recorded in a subtitle file, such as:

(0.5)She(0.3)may(0.4)be

(0.3)the(0.5)face(0.2)I

(0.6)cannot(0.5)forget

In this example, the shown delimiter is recorded following the word, and accompanied word by word. For example, “(0.5)She” indicates that the word “She” will last 0.5 seconds. Furthermore, a certain word can be highlighted by a predetermined delimiter. Accordingly, the lyrics can be displayed with the music synchronously.

The foregoing description shows the conventional technologies have provided a synchronous way to play the music with the lyrics, and can be applicable to displaying subtitle with a video. Nevertheless, the subtitle and the content of some movies or music videos (MV) have been combined when they are produced, and without any correlation with the playing environment.

### SUMMARY OF THE INVENTION

The present invention generally relates to a multimedia subtitle display system and method. One of the objects of the present invention is to dynamically and synchronously displaying the subtitle in accordance with every kind of the hardware or software used for a multimedia player. More particularly, the invention is applicable to a multimedia playback system which employs a system information detection means. The system information detection means is to read a multimedia file and a subtitle file respectively, and to determine a suitable way to display the subtitle by referring to the detected hardware or software of the multimedia playback system.

According to a preferred embodiment of the present invention, the method of displaying the multimedia subtitle is particularly provided to incorporate a system detection routine in the multimedia playback system. The system detection routine is executed after activating the system. Firstly, the multimedia file and the subtitle file are read by the routine. A specific identification between the multimedia file and the subtitle is used to recognize a link therebetween. The identification can prevent any wrong recognition.

Next, the invention determines a subtitle display sequence regarding the subtitle by reading the text tags recorded in the subtitle file. The text tags may involve every type of display effects, a start time, and an end time.

More particularly, the system detection routine further reads the system information from the multimedia playback system, including the information with respect to the system's hardware and software. By which, the display resolution and system language of the multimedia playback system can be determined. According to the display resolution, the system language, and the subtitle display sequence, it's to decide a suitable display mode.

Another embodiment of the present invention is to provide a system of displaying multimedia subtitle. The system includes a subtitle file having a plurality of texts with text tags. The text tags are used to regulate a subtitle display sequence. The system further includes a multimedia file having a correlation with the subtitle file. Through a system information detection means loaded in a multimedia playback system, it's to decide a suitable display mode of the multimedia playback system as reading the subtitle file and the multimedia file, and further referring to the system information.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of displaying lyrics with music in accordance with each delimiter in a subtitle file in a conventional art;

FIG. 2 is an example of the delimiter recorded in the subtitle file of the conventional art;

FIG. 3 shows a schematic diagram of the multimedia subtitle display system of the present invention;

FIG. 4 shows a schematic diagram of an embodiment of dynamically regulating the subtitle by the claimed method of the present invention;

FIG. 5 shows a schematic diagram of a second embodiment of dynamically regulating the subtitle of the displaying method of the present invention;

FIG. 6 shows a schematic diagram of the embodiment of multimedia subtitle display System of the present invention;

FIG. 7 shows a flow chart of embodiment of the multimedia subtitle display method of the present invention.

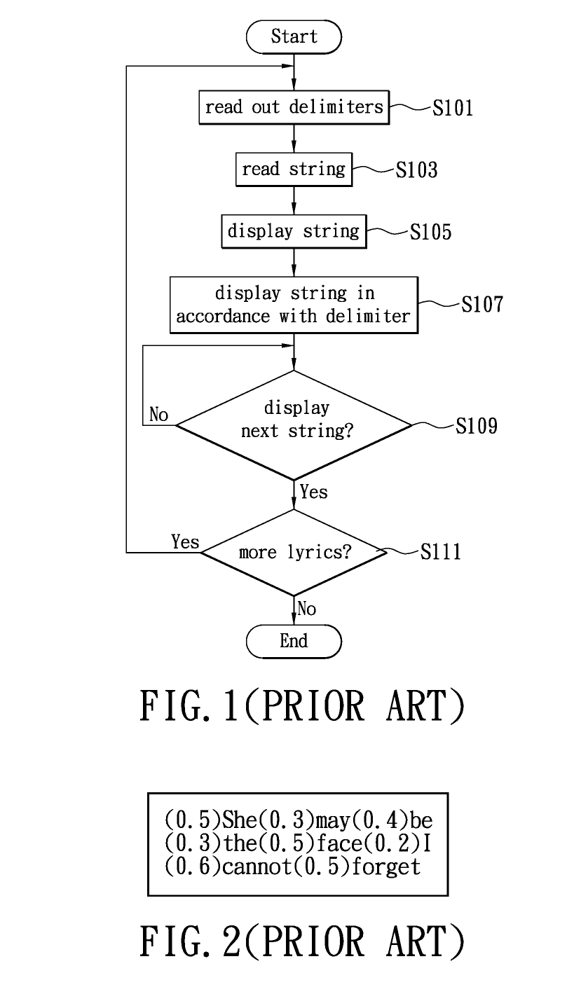

### DETAILED DESCRIPTION OF THE PREFERRED EMBODIMENTS

It is different from the way to combine the image and words in the conventional art, or the synchronous method to play the image, music and words, provided is system and method for displaying the multimedia subtitle. One of the objects is to dynamically display the subtitle, which is synchronous with the multimedia content, in accordance with variant hardware or software of a multimedia player.

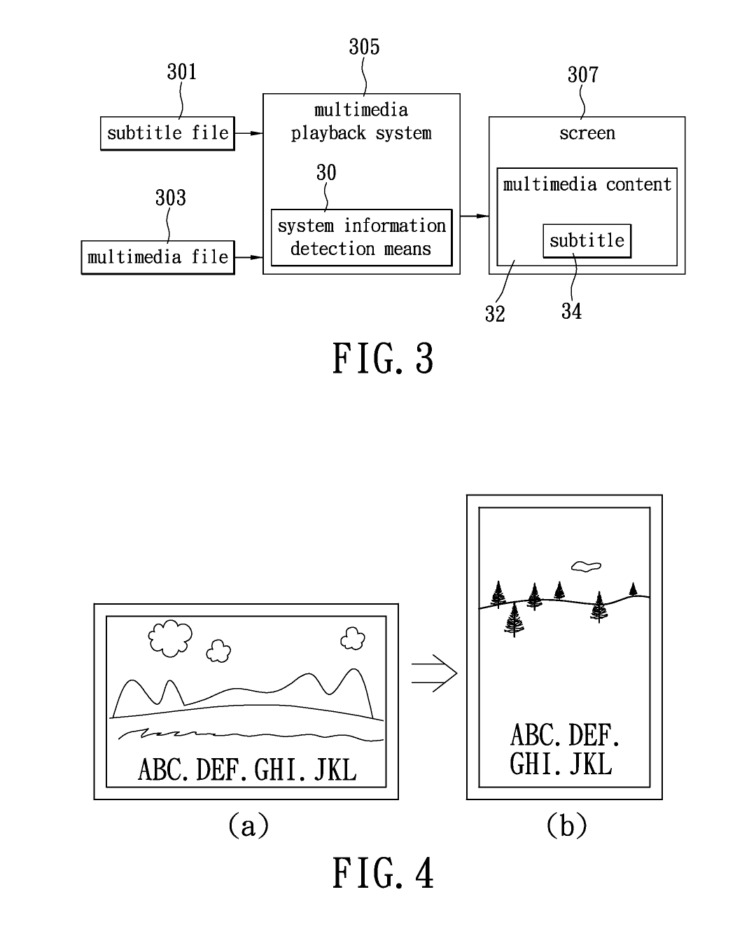

The preferred embodiment of the present invention is referred to FIG. 3 showing a schematic diagram of the multimedia subtitle display system. A multimedia playback system 305 is shown, and an inside system information detection means 30 is particularly introduced. The system information detection means 30 is usually implemented as a software program that separately reads the subtitle file 301 and the multimedia file 303 in the system. The text tags written in the subtitle file 301 are used to determine the subtitle display sequence, and then to decide a suitable display mode as reading system information of the multimedia playback system 305. After that, the multimedia content 32 accompanied with subtitle 34 is displayed on the screen 307.

More particularly, the mentioned system information of the multimedia playback system 305 regards the information of hardware or software. In the preferred embodiment, the claimed system can detect the performance of hardware in real time as playing the multimedia. The playing environment, such as display resolution and size, dominates the system information. The system information detection means not only separately reads multimedia file and subtitle file, but also suitably displays the subtitle by referring to the detected system information including the hardware or playing software.

Reference is made to FIG. 4 showing a schematic diagram of an embodiment of dynamically regulating the subtitle by the claimed method of the present invention. The diagram (a) shows a video displayed on a screen of a player. The video is played with the subtitle synchronously. For example, users may follow KTV or MTV with corresponding music and subtitle to sing.

In this case, the resolution of screen allows to display a complete row of subtitle such as the shown example of “ABC.DEF.GHI.JKL”. The diagram (b) shows a condition of the multimedia being played vertically changed from the horizontal displaying. In the meantime, the claimed system information detection means detects the change of condition, and regulates the state of displaying the subtitle. In the current embodiment shown in the diagram, the subtitle is divided into two rows in order to suitably display the complete words in that period, wherein the upper portion shows “ABC.DEF.”, and the lower portion shows “GHI.JKL”. In particular, by means of the method of the present invention, the subtitle may not be proportioned in compliance with the change of multimedia. Instead, the subtitle can be displayed clearly under the variant displaying environment.

In the embodiment shown in the FIG. 4, the method can be applicable to the system equipped with an electronic gyroscope. Since the system information detection means can read out the system information of the system, the directional information regarding the change of angular momentum sensed by the electronic gyroscope can be read in the meantime. Furthermore, the subtitle is regulated based the resolution of screen.

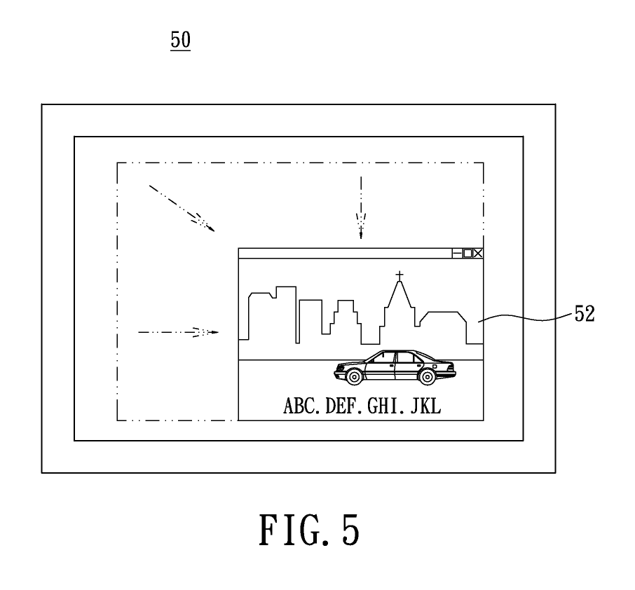

FIG. 5 shows a schematic diagram of a second embodiment of dynamically regulating the subtitle of the displaying method of the present invention. In this embodiment, a player 50 utilizes a software program to play the multimedia. This software program is also utilized by the claimed system information detection means for reading an operating status.

In the current exemplary example, a display area 52 is regulated as the playback software changes the status. In practice, the change of the play area 52 of the software can be detected by the system information detection means. After acknowledging the change of play area 52, the subtitle is regulated for displaying. The display mode can be implemented as a line-breaking mode or a size-scaling mode, and the subtitle corresponds with the multimedia content.

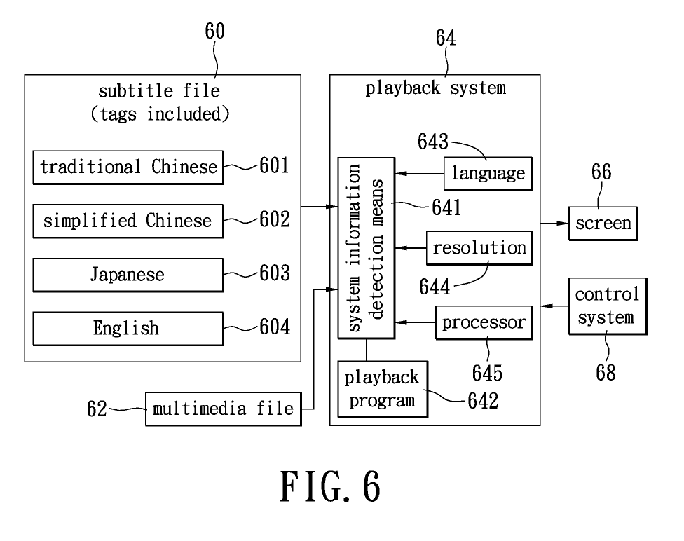

Reference is made to FIG. 6 illustrating a schematic diagram of the embodiment of multimedia subtitle display System. This diagram illustrates a correlation used to associate the subtitle file 60, multimedia file 62, with the multimedia playback system 64.

The subtitle file 60 records the texts with a plurality of text tags, and a subtitle display sequence of the texts can be determined. The sequence includes a lasting time for each word or section, and some other effects such color, font, brightness, fading in, and fading-out. More, the position to break the sentence, a start time, and an end time of the paragraph is also included in the sequence. If the music is progressing in the section of male and female duet, the text tags can be used to mark the respective parts of lyrics for male and female. More, the users may sing and synchronously follow the prompts word by word to a karaoke accompaniment.

After reading the multimedia file 62, the system information detected by the system information detection means 641 at least includes playback length of the multimedia and its timing information. Then the timing expressed by the text tags is collocated with the subtitle or lyrics which are synchronously played with the multimedia.

The claimed system and method further provide the language configuration. Single subtitle file can save various languages for the same content for complying with the requirement by the playback system. The example shown in the figure provides the system supporting traditional Chinese 601, simplified Chinese 602, Japanese 603, and English 604. A language with corresponding to the playback system is used when the system information detection means determines the system language, so as to eliminate the wrong display or erroneous coding.

Since the subtitle file 60 and the multimedia file 62 are two separate files, a correlation is required be an identification for linking each other. For example, the correlation between the two files can be simply the same file name, and the multimedia playback system will identify they are the two corresponding files. Some IDs can also be the correlations.

Particularly, the claimed multimedia playback system 64 incorporates the system information detection means 641. The system information detection means 641 reads the subtitle file 60 and the multimedia file 62 after the system activates. The means 641 further reads the system information regarding the multimedia playback system 64, such as the system language 643, screen resolution 644, and the performance of processor 645. The system language 643 is used to determine the language of subtitle. The screen resolution 644 of the system is used to determine the display status of subtitle. Since the detection means operates in real time, any change with respect to the resolution (including the size) or system language will dynamically regulate the line-breaking position of the subtitle. Furthermore, the regulation includes changing the size to display and the system language instantaneously. The size to display may be changed non-proportionally.

The information provided by the processor 645 can be an alternative choice. The system information detection means 641 detects the digital data processing capability such as to detect whether or not the processor 645 simultaneously handles another procedure. Thereby the means 641 determines the current status of displaying in order to provide an optimum display mode. In which, the display resolution or the size can be regulated.

When the users activates the multimedia playback system 64 through a control system 68, the system information detection means 641 is immediately to determine the display resolution, system language, a subtitle display sequence, or other parameters in order to decide a display mode of the multimedia and the subtitle. Thus the paragraphic position of the subtitle is determined, and the playback program 642 can play the multimedia content involving the multimedia and subtitle on the screen 66.

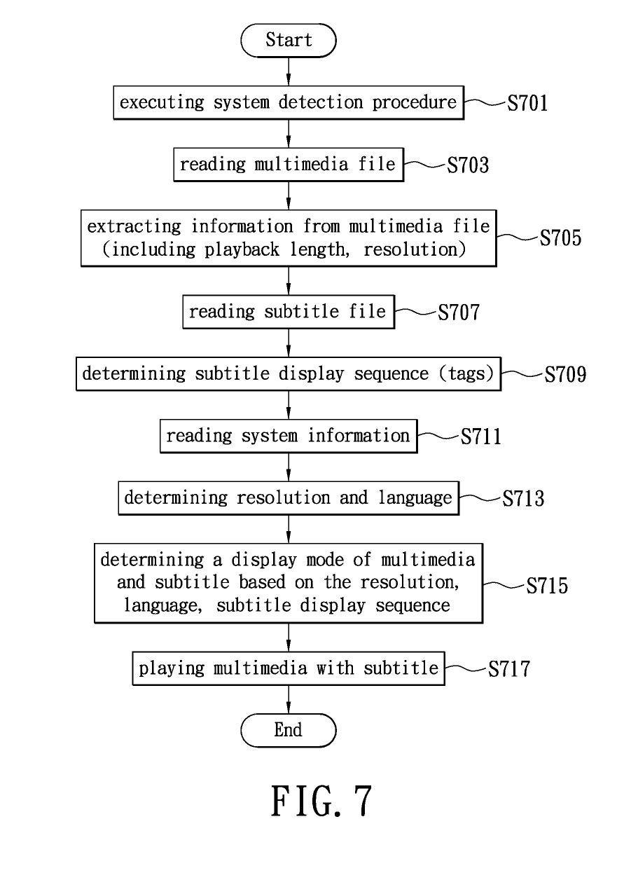

FIG. 7 shows a flow chart of embodiment of the multimedia subtitle display method of the present invention.

The users may activate the multimedia playback system through a control system such as the element 68 of FIG. 6. Preferably the system detection routine is then executed in step S701. This routine reads both the multimedia files and the subtitle file. When the subtitle is read in step S703, the information recorded in the multimedia file in extracted, the information at least includes a playback length, resolution, and timing information (step S705). When the subtitle file is read in step S707, the system may utilize the text tags to determine the subtitle display sequence (step S709). The multimedia file and the subtitle file particularly have a correlation relationship used to identify the connection therebetween, in order to prevent the wrong reading.

The system detection routine further reads the above-described system information of the multimedia playback system (step S711), that is to detect the resources of hardware and software therefor. In step S713, the system information can be the display resolution and system language of multimedia playback system. Based on the information of display resolution, system language, and the subtitle display sequence, a suitable display mode is decided (step S715). At last, the system is to play the combined multimedia and its subtitle in step S717.

More particularly, the mentioned system detection routine in steps S701 and S711 is a constant procedure of the method for displaying the multimedia subtitle of the present invention. The display resolution and system language can be immediately detected once the display environment changes. Moreover, the display mode is also dynamically changed.

In the summation of the above description, the method and system for displaying the multimedia subtitle is to utilize an inside system detection routine to regulate the subtitle display sequence besides to read the text tags. Furthermore, the system information is also read for deciding a suitable display mode.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for displaying multimedia subtitle, comprising:
executing a system detection routine, wherein the system detection routine is executed as initiating a multimedia playback system;
reading a subtitle file, wherein the subtitle file and the multimedia file has a correlation;
determining a subtitle display sequence by a plurality of text tags recorded in the subtitle file;
reading system information of the multimedia playback system;
determining a display resolution and a system language of the multimedia playback system;
deciding a display mode of the multimedia file and the subtitle file based on the display resolution, the system language, and the subtitle display sequence; and
playing a multimedia content combining the multimedia file and the subtitle file using the display mode.

2. The method of claim 1, wherein the method is to retrieve the information from the multimedia file after reading the multimedia file, and the information at least includes a playback length, and timing information.

3. The method of claim 1, further comprising an identification which is used be a correlation between the subtitle file and the multimedia file.

4. The method of claim 1, wherein the text tags are used to regulate the subtitle display sequence which rules a display status of the multimedia playback system, and the display status at least includes one or in combination of the followings:
a display time;
a display effect;
a plurality of texts for each voice part;
a text paragraph;
a start time and an end time for displaying the texts; and
a prompt symbol.

5. The method of claim 1, wherein the system detection routine determines a plurality of paragraphic positions used for displaying the subtitle according to the display resolution of the multimedia playback system.

6. The method of claim 5, wherein the system detection routine determines the size of the subtitle according to the display resolution of the multimedia playback system.

7. The method of claim 1, wherein the subtitle file records the texts corresponding to a plurality of languages.

8. The method of claim 7, wherein the step of deciding the display mode is to decide a language regulated in the subtitle file according to the system language.

9. The method of claim 1, wherein the system detection routine is used to repeat the steps of the method after the step of playing.

10. The method of claim 9, wherein through a real-time detection, the display resolution and the system language of the multimedia playback system are detected in real time when display environment for the multimedia playback system changes.

11. The method of claim 10, wherein the display resolution is dynamically regulated.

12. The method of claim 1, wherein the system information of the multimedia playback system includes the display resolution, the system language, and a capability of processing digital data.

13. The method of claim 10, wherein the system information further includes a play area of a playback program.

14. A system of displaying multimedia subtitle, comprising:
a subtitle file, including a plurality of texts with text tags, wherein the text tags are used to regulate a subtitle display sequence;
a multimedia file having a correlation with the subtitle file; and
a multimedia playback system having a system information detection means, wherein the multimedia playback system reads the subtitle file and the multimedia file, and determines the subtitle display sequence based on the text tags; and the system information detection means is used to read system information of the system and determine a display resolution and a system language;
whereby the system information detection means decides a display mode of the multimedia file and the subtitle file, and determines paragraphic position of the subtitle according to the display resolution, the system language and the subtitle display sequence, and the multimedia is played subsequently.

15. The system of claim 14, wherein the correlation is an identification interconnected with the subtitle file and the multimedia file.

16. The system of claim 14, wherein a play status is determined through the text tags, and the play status includes one or in combination of the followings:
a display time;
a display effect;
a plurality of texts for each voice part;
a text paragraph;
a start time and an end time for displaying the texts; and
a prompt symbol.

17. The system of claim 14, wherein the subtitle file records a plurality of languages.

18. The system of claim 14, wherein the system information detection means is a procedure of detecting the system information of the multimedia playback system in real time.

19. The system of claim 18, wherein the system information of the multimedia playback system includes the display resolution, and the system language, further comprises a capability of processing digital data, and a play area of a playback program.

20. The system of claim 18, wherein the method is to determine the display resolution and the system language in real time when the display environment of the multimedia playback system changes.
